(19) United States
(12) Patent Application Publication
(10) Pub. No.: US 2026/0012019 A1
(43) Pub. Date: Jan. 8, 2026

(54) POWER SUPPLY SYSTEM

(71) Applicant: TOYOTA JIDOSHA KABUSHIKI KAISHA, Toyota-shi (JP)

(72) Inventors: Yuya MIYAZONO, Toyota-shi (JP); Ryohei CHINO, Nisshin-shi (JP); Hironaga ONO, Toyota-shi (JP)

(73) Assignee: TOYOTA JIDOSHA KABUSHIKI KAISHA, Toyota-shi (JP)

(21) Appl. No.: 19/076,198

(22) Filed: Mar. 11, 2025

(30) Foreign Application Priority Data
Jul. 8, 2024 (JP) 2024-109533

(51) Int. Cl. H02J 3/32; B60L 53/30; H02H 3/10; H02J 3/00; H02J 3/14; H02J 3/38; H02J 7/02

(52) U.S. Cl. CPC H02J 3/322; B60L 53/30; H02H 3/105; H02J 3/001; H02J 3/14; H02J 3/38; H02J 7/02; H02J 2300/24; H02J 2310/12

(57) ABSTRACT

In a power supply system, a power supply device supplies alternating current power from a vehicle to a load when the vehicle is connected to the power supply device. A first electromagnetic switch can switch between electrically connecting and disconnecting an earth leakage breaker to and from an overcurrent breaker. A second electromagnetic switch can switch between electrically connecting and disconnecting the first electromagnetic switch to and from the power supply device, and can switch between electrically connecting and disconnecting the overcurrent breaker to and from the power supply device. An ammeter measures a current value between the overcurrent breaker and the load. The power supply system closes the first electromagnetic switch and opens the second electromagnetic switch when the vehicle is connected to the power supply device and a measured value from the ammeter is greater than a threshold β.

### CROSS-REFERENCE TO RELATED APPLICATION

This application claims priority to Japanese Patent Application No. 2024-109533 filed on Jul. 8, 2024. The disclosure of the above-identified application, including the specification, drawings, and claims, is incorporated by reference herein in its entirety.

### BACKGROUND

### 1. Technical Field

The present disclosure relates to power supply systems.

### 2. Description of Related Art

In a power supply system that can supply power from a grid power supply to power loads of a house, power from a vehicle may be supplied to the power loads mainly in case of emergency (such as in case of a power failure of the grid power supply or a shortage of power from the grid power supply). It has also been proposed to supply power from a vehicle to power loads on a daily basis (for example, peak electricity hours for the grid power supply). Japanese Unexamined Patent Application Publication No. 2019-71721 (JP 2019-71721 A) discloses a power supply system that can use power stored in an electrified vehicle in case of a power outage.

### SUMMARY

Alternating current power that is supplied from a grid power supply and alternating current power that is supplied from a vehicle have different phases. Therefore, it is not preferable to supply alternating current power from a grid power supply and alternating current power from a vehicle to a power load at the same time. It is desirable that power supply from a vehicle to a power load can be implemented with the simplest possible system configuration.

The present disclosure was made to solve the above issue, and one object of the present disclosure is to provide a power supply system that can supply power from a vehicle to a power load using a simple system configuration.

A power supply system according to an aspect of the present disclosure is configured to supply alternating current power from a grid power supply to a power load in a house. The power supply system includes a current breaker, a load breaker, a power converter, a first switch, a second switch, and a measuring instrument. The current breaker is configured to receive the alternating current power supplied from the grid power supply to the house and to shut off in case of either or both of an earth leakage and an overcurrent. The load breaker is configured to electrically disconnect the current breaker from the power load. The power converter is configured to supply alternating current power from a vehicle to the power load when the vehicle is connected to the power converter. The first switch is configured to switch between electrically connecting and disconnecting the current breaker to and from the load breaker. The second switch is configured to switch between electrically connecting and disconnecting the first switch to and from the power converter, and is configured to switch between electrically connecting and disconnecting the load breaker to and from the power converter. The measuring instrument is configured to measure at least one of the following values between the load breaker and the power load: a current value, a voltage value, and a power value. The power supply system is configured to close the first switch and open the second switch when the vehicle is connected to the power converter and a measured value from the measuring instrument is greater than a threshold.

According to the present disclosure, power can be supplied from a vehicle to a power load using a simple system configuration

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a circuit block diagram illustrating a first example of a configuration of a power supply system according to a first embodiment;

FIG. 2 is a circuit block diagram illustrating a second example of a configuration of a power supply system according to the first embodiment;

FIG. 3 is a flowchart illustrating a first example of a processing procedure related to control of an electromagnetic switch;

FIG. 4 is a circuit block diagram illustrating a first example of a configuration of a power supply system according to a second embodiment;

FIG. 5 is a circuit block diagram illustrating a second example of a configuration of a power supply system according to the second embodiment;

FIG. 6 is a circuit block diagram illustrating a third example of a configuration of a power supply system according to the second embodiment;

FIG. 7 is a circuit block diagram illustrating a fourth example of a configuration of a power supply system according to the second embodiment;

FIG. 8 is a flowchart illustrating a second example of a processing procedure related to control of an electromagnetic switch;

FIG. 9 is a flow chart showing a third example of a process for controlling an electromagnetic switch; and

FIG. 10 is a circuit block diagram illustrating a modification of the first example of the configuration of the power supply system according to the first embodiment.

### DETAILED DESCRIPTION OF EMBODIMENTS

Hereinafter, embodiments of the present disclosure will be described in detail with reference to the drawings. It should be noted that the same or corresponding portions in the drawings are designated by the same reference signs and repetitive description will be omitted.

### First Embodiment

### System Configuration

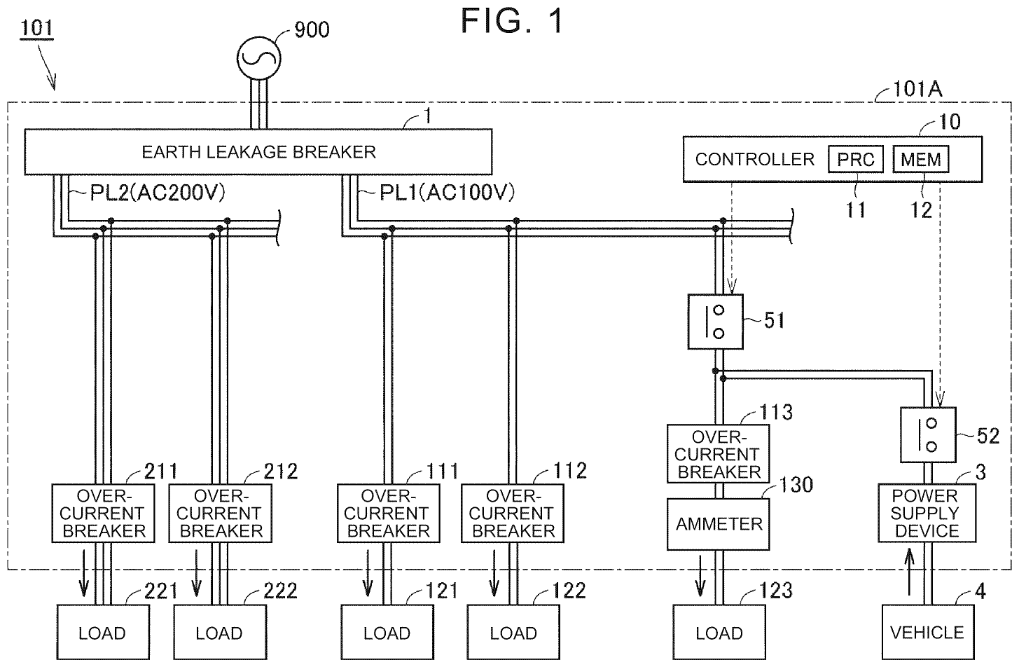

FIG. 1 is a circuit block diagram illustrating a first example of a configuration of a power supply system according to a first embodiment. The power supply system 101 supplies power from the grid power supply 900 to the loads on the house 101A. The house 101A is typically a house (building in which a person resides). However, the house 101A may include non-residential buildings, e.g., buildings, buildings housing facilities, etc. The loads are, for example, various electric devices, but may be disposed inside (indoors) or outside (outdoors) the house 101A.

The power supply system 101 includes an earth leakage breaker 1, overcurrent breakers 111 to 113, 211, and 212, a power supply device 3, and an ammeter 130. The number of the overcurrent breakers is not particularly limited. Note that the ammeter 130 is an example of a “measuring instrument” of the present disclosure.

The earth leakage breaker 1 receives alternating current power supplied from the grid power supply 900 to the house 101A. An electrical path PL1 for transmitting the alternating current power of AC 100 V and an electrical path PL2 for transmitting the alternating current power of AC 200 V are connected to the earth leakage breaker 1. The earth leakage breaker 1 electrically shuts off the grid power supply 900 and the electrical paths PL1, PL2 when an earth leakage is detected. The earth leakage breaker 1 corresponds to a “current breaker” according to the present disclosure.

The overcurrent breakers 111 to 113 are electrically connected to the electrical path PL1 for AC 100 V. Although not shown, the house 101A includes a plurality of rooms. For example, a load 121 may be provided in one room, a load 122 may be provided in another room, and a load 123 may be provided in another room. The overcurrent breakers 111 to 113 are provided corresponding to different rooms in the house 101A. The overcurrent breakers 111 to 113 are configured to electrically disconnect the earth leakage breaker 1 from the loads 121 to 123, respectively, when an overcurrent is detected. The overcurrent breaker 113 corresponds to a “load breaker” according to the present disclosure. Each load corresponds to a “power load” according to the present disclosure.

The overcurrent breakers 211, 212 are electrically connected to an electrical path PL2 for AC 200 V. The overcurrent breakers 211, 212 are provided in rooms differing from each other in the house 101A in the same manner as the overcurrent breakers 111 to 113 for AC 100 V. The overcurrent breakers 211, 212 are configured to electrically disconnect the earth leakage breaker 1 from the loads 221, 222, respectively, when an overcurrent is detected.

The power supply device 3 is configured to be connected to the vehicle 4 via a power supply cable (not shown). The vehicle 4 is an electrified vehicle equipped with a traveling battery and configured to receive and supply electric power from and to the outside of the vehicle. Specifically, the vehicle 4 is a BEV (Battery Electric Vehicle) or a PHEV (Plug-in Hybrid Electric Vehicle). The power supply device 3 includes a AC/DC converter, and is configured to supply alternating current power from the vehicle 4 to a load (in this case, the load 123) when the vehicle 4 is connected. The power supply device 3 is an example of a “power converter” according to the present disclosure.

The ammeter 130 measures a current value flowing between the overcurrent breaker 113 and the load 123. Instead of the ammeter, a voltmeter for measuring a voltage value or a power meter for measuring a power value may be provided. Two or all of an ammeter, a voltmeter, and a power meter may be provided.

The power supply system 101 further includes a first electromagnetic switch 51, a second electromagnetic switch 52, and a controller 10.

The first end of the first electromagnetic switch 51 is electrically connected to an electrical path PL1 for AC 100 V. The second end of the first electromagnetic switch 51 is electrically connected to the overcurrent breaker 113. Thus, the first electromagnetic switch 51 is configured to switch between electrically connecting and disconnecting the earth leakage breaker 1 to and from the overcurrent breaker 113 according to a control command from the controller 10.

The first end of the second electromagnetic switch 52 is electrically connected to the second end of the first electromagnetic switch 51 and is electrically connected to the overcurrent breaker 113. A second end of the second electromagnetic switch 52 is electrically connected to the power supply device 3. Accordingly, the second electromagnetic switch 52 is configured to switch between electrically connecting and disconnecting the first electromagnetic switch 51 to and from the power supply device 3 and switch between electrically connecting and disconnecting the overcurrent breaker 113 to and from the power supply device 3 according to a control command from the controller 10.

Although not shown, the earth leakage breaker 1 and the overcurrent breakers 111 to 113, 211, and 212 are provided in a distribution board (may be a distribution board depending on the type of the house 101A). In the case of a distribution board having a large size, the first electromagnetic switch 51 and the second electromagnetic switch 52 may be disposed inside the distribution board. In the case of a distribution board having a small size, the first electromagnetic switch 51 and the second electromagnetic switch 52 may be disposed in a housing externally attached to the distribution board and provided near the distribution board.

The first electromagnetic switch 51 corresponds to the “first switch” according to the present disclosure, and the second electromagnetic switch 52 corresponds to the “second switch” according to the present disclosure. The first electromagnetic switch 51 and the second electromagnetic switch 52 are also generally referred to as “electromagnetic switches”.

The controller 10 is a computer device including the processor 11 and the memory 12, and is, for example, an HEMS (Home Energy Management System) controller. The controller 10 outputs a control command for opening and closing (turning on and off) each of the first electromagnetic switch 51 and the second electromagnetic switch 52. As will be described later, the controller 10 may be able to acquire power information (power transaction information, electricity rate information, etc.) of the grid power supply 900 from an energy management server (not shown), and open and close the first electromagnetic switch 51 and the second electromagnetic switch 52 according to the acquired power information. In addition, the controller 10 may be able to control the power supply device 3 according to the acquired power information (that is, supplying power from the vehicle 4). The controller 10 corresponds to the “control device” according to the present disclosure.

The alternating current power supplied from the grid power supply 900 and the alternating current power supplied from the vehicle 4 have different phases. Therefore, it is not preferable to simultaneously supply the alternating current power from the grid power supply 900 and the alternating current power from the vehicle 4 to the loads 121 to 123. According to the first embodiment, the first electromagnetic switch 51 and the second electromagnetic switch 52 can be used to select which of the two alternating current powers is to be supplied from the load 121 to the load 123.

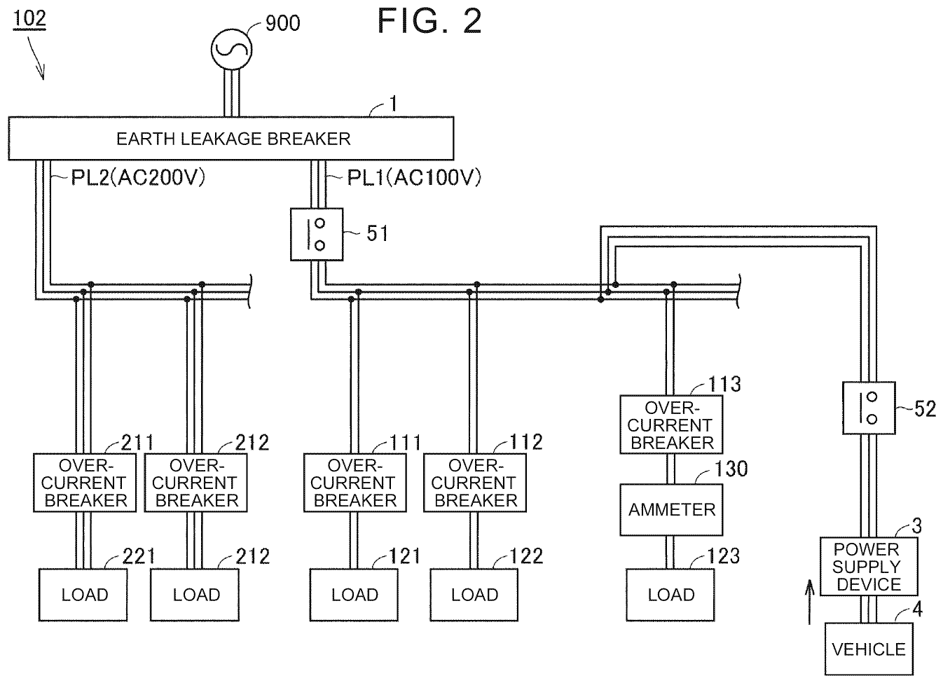

FIG. 2 is a circuit block diagram illustrating a second example of a configuration of a power supply system according to the first embodiment. In order to avoid complication of the drawings, the house 101A and the controller 10 are not shown in FIG. 2 and the subsequent figures.

The power supply system 102 shown in FIG. 2 differs from the power supply system 101 shown in FIG. 1 in that the first electromagnetic switch 51 is electrically connected to the electrical path PL1 for AC 100 V and that the second electromagnetic switch 52 is electrically connected to the electrical path PL1 for AC 100 V.

In the power supply system 101 shown in FIG. 1, a first electromagnetic switch 51 is provided at a position corresponding to the upstream of the overcurrent breaker 113. Therefore, only the overcurrent breaker 113 is cut off from the earth leakage breaker 1 by opening and closing the first electromagnetic switch 51. On the other hand, the first electromagnetic switch 51 shown in FIG. 2 is provided not only at a position corresponding to the upstream of the overcurrent breaker 113 but also at a position corresponding to the upstream of the overcurrent breaker 111,112 in another room. Therefore, when the first electromagnetic switch 51 is opened, all of the three overcurrent breakers 111 to 113 of the first electromagnetic switch 51 are cut off from the earth leakage breaker 1.

As described above, the position of the first electromagnetic switch 51 is not limited as long as it can switch between electrically connecting and disconnecting the earth leakage breaker 1 to and from at least one overcurrent breaker. The first electromagnetic switch 51 may be disposed anywhere as long as it can switch between connecting and disconnecting the earth leakage breaker 1 to and from at least one of the overcurrent breakers 111 to 113.

In addition, in the second example, the first end of the second electromagnetic switch 52 is electrically connected to the electrical path PL1 for AC 100 V (i.e., single-phase three-wire). As a result, alternating current power from the vehicle 4 can be supplied not only to the load 123 but also to other loads 121,122.

Since the configuration of the power supply system 102 other than the arrangement of the first electromagnetic switch 51 and the second electromagnetic switch 52 is the same as the corresponding configuration of the power supply system 101, the detailed description thereof will not be repeated.

Note that another electromagnetic switch (not shown) instead of the first electromagnetic switch 51 may be electrically connected, for example, between the overcurrent breaker 113 and the load 123 (in other words, a position corresponding to the downstream side of the load 123).

### Process Flow

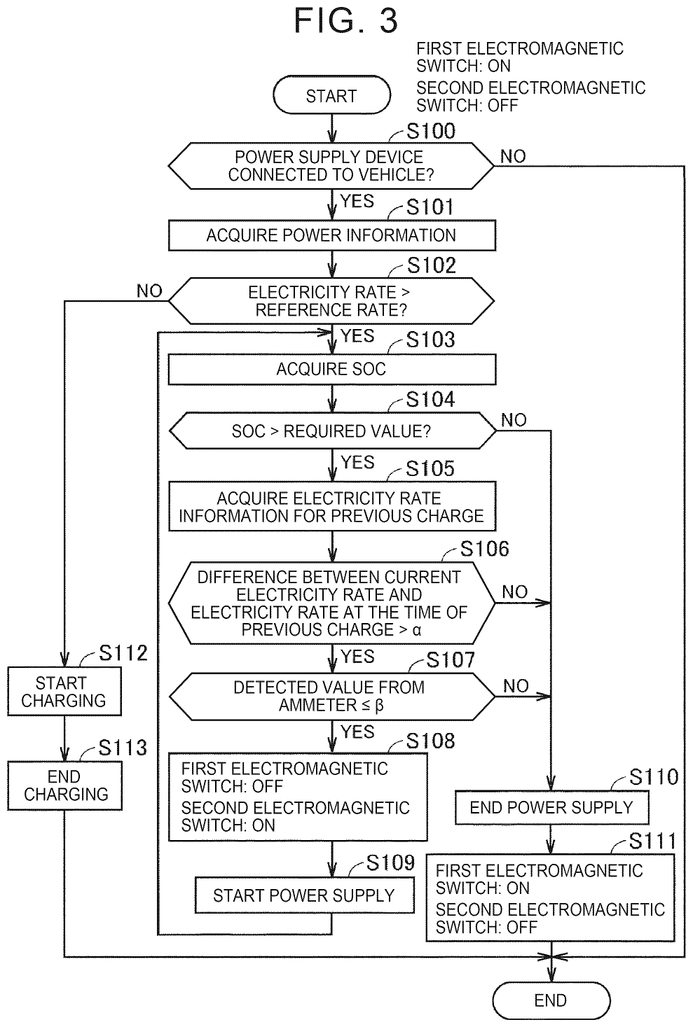

FIG. 3 is a flowchart illustrating a first example of a processing procedure related to control of an electromagnetic switch. The processing illustrated in this flowchart is executed when a predetermined condition is satisfied (for example, every predetermined cycle). Each step is realized by software processing by the controller 10 (processor 11), but may be realized by hardware (electric circuit) arranged in the controller 10. Hereinafter, the term “step” is abbreviated as S. The same applies to other flowcharts described later.

Here, the power supply system 101 shown in FIG. 1 will be described as an example. It is assumed that the first electromagnetic switch 51 is on (closed) and the second electromagnetic switch 52 is off (open) at the start of a series of processes.

Referring to FIGS. 1 and 3, in S100, the controller 10 determines whether the power supply device 3 is connected to the vehicle 4. When the power supply device 3 is connected to the vehicle 4 (YES in S100), the controller 10 proceeds to S101. When the power supply device 3 is not connected to the vehicle 4 (NO in S100), the controller 10 ends the process. Note that S100 process may be omitted.

In S101, the controller 10 obtains power information (in this case, current electricity rate information) of the grid power supply 900 from, for example, an energy-management server (not shown).

In S102, the controller 10 determines whether the current electricity rate obtained in S101 is higher than a reference rate (e.g., the average electricity rate on that day). When the current electricity rate is higher than the reference rate (YES in S102), the controller 10 proceeds to S103.

In S103, the controller 10 acquires the state of charge (SOC: State Of Charge) of the battery mounted on the vehicle 4 through communication with the vehicle 4 or the like. The controller 10 then determines whether the acquired SOC is higher than the required value (S104). The required value is, for example, a value corresponding to the amount of electric power required for driving the next day of the vehicle 4. The required value may be a fixed value determined in advance or may be a variable value determined in accordance with the actual use of the vehicle 4.

If SOC is higher than required (YES in S104), the controller 10 proceeds to S105. When the SOC is equal to or less than the required value (NO in S104), the controller 10 proceeds to S109.

In S105, the controller 10 acquires, for example, from an energy management server (not shown), information on the electricity rate when the vehicle 4 was last charged. Then, in S106, the controller 10 calculates a difference between the current electricity rate whose information was acquired in S101 and the electricity rate at the time of the previous charge whose information was acquired in S105, and determines whether the difference therebetween is equal to or greater than the threshold α. When the difference is greater than the threshold α (YES in S106), the controller 10 proceeds to S107. When the difference is equal to or less than the threshold α (NO in S106), the controller 10 proceeds to S110. In the present embodiment, the threshold α is a positive value, but the threshold α may be 0. Although the above-described difference is calculated in the present embodiment, the determination equivalent to S106 may be performed based on the ratio (b/a) between b and a, for example, instead of the above-described difference.

Here, for the purpose of explanation, the current electricity rate and the electricity rate at the time of the previous charging are denoted as a and b, respectively. Further, the free capacity of the electric power in the load 123 is x. Further, the amount of power (power loss) consumed by ECU etc. when the vehicle 4 is charged is set to L. In this case, the revenue obtained by the user when the vehicle 4 is discharged to the load 123 is bx−ax−aL. In order for bx−ax−aL to be greater than 0, the condition of (b−a)>aL/x needs to be satisfied. That is, the smaller the difference between b and a, the larger the threshold of x for the user to obtain a profit. The controller 10 may set aL/x to the threshold α, or may set the sum of aL/x and any value to the threshold α. As a result, it is possible to reduce a monetary loss from occurring due to the power supply from the vehicle 4 to the load 123. Note that the controller 10 may acquire the information of x from the load 123. Further, L may be a fixed value stored in the memory 12 (FIG. 1).

Note that, in S105, the electricity rate at the time of the previous charge is acquired, but the present disclosure is not limited thereto. For example, in the case where the power currently stored in the vehicle 4 is stored by a plurality of charges performed in the past, information on an average value of the electricity rates for the plurality of charges may be acquired.

In S107, the controller 10 determines whether or not the measured value (current value) from the ammeter 130 is equal to or less than the threshold β. The threshold β is a value set so as not to exceed the discharge capacity of the vehicle 4 when the vehicle 4 is powered. The threshold β may be a fixed value set in advance in the memory 12 or the like, or may be a value calculated each time based on the condition (e.g., SOC etc.) of the vehicle 4. When the measured value from the ammeter 130 is equal to or less than the threshold β (YES in S107), the controller 10 proceeds to S108. When the measured value from the ammeter 130 is greater than the threshold β (NO in S107), the controller 10 proceeds to S110.

The controller 10 turns off the first electromagnetic switch 51 and turns on the second electromagnetic switch 52 (S108). Then, the controller 10 controls the power supply device 3 so that the power supply from the vehicle 4 to the load 123 is started (S109), and returns to S103.

When the power supply from the vehicle 4 is continued, SOC decreases over time. When the SOC becomes equal to or less than the required value (NO in S104), the controller 10 controls the power supply device 3 to terminate the power supply from the vehicle 4 to the load 123 (S110). The controller 10 turns on the first electromagnetic switch 51 and turns off the second electromagnetic switch 52 (S111). As a result, the series of processing ends.

As can be seen from the flowchart of FIG. 3, when S107 process is performed again after S108 process is performed and the detected value is greater than the threshold β (NO in S107), the first electromagnetic switch 51 is switched from the off-state to the on-state in S111. In addition, the second electromagnetic switch 52 is switched from the on state to the off state.

When S108 process is not performed and the first electromagnetic switch 51 is in the on state and the second electromagnetic switch 52 is in the off state, and the detected value is greater than the threshold β in S107 process (NO in S107), the on state of the first electromagnetic switch 51 and the off state of the second electromagnetic switch 52 are maintained in S111. In other words, in this case, the first electromagnetic switch 51 is prohibited from being opened (turned off) and the second electromagnetic switch 52 is prohibited from being closed (turned on).

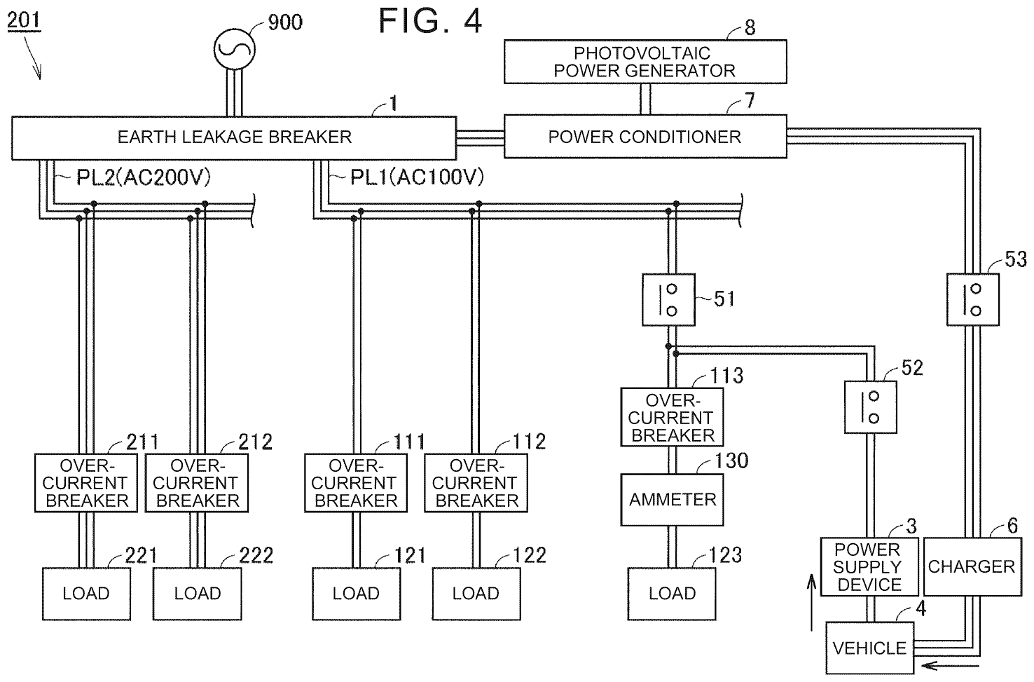

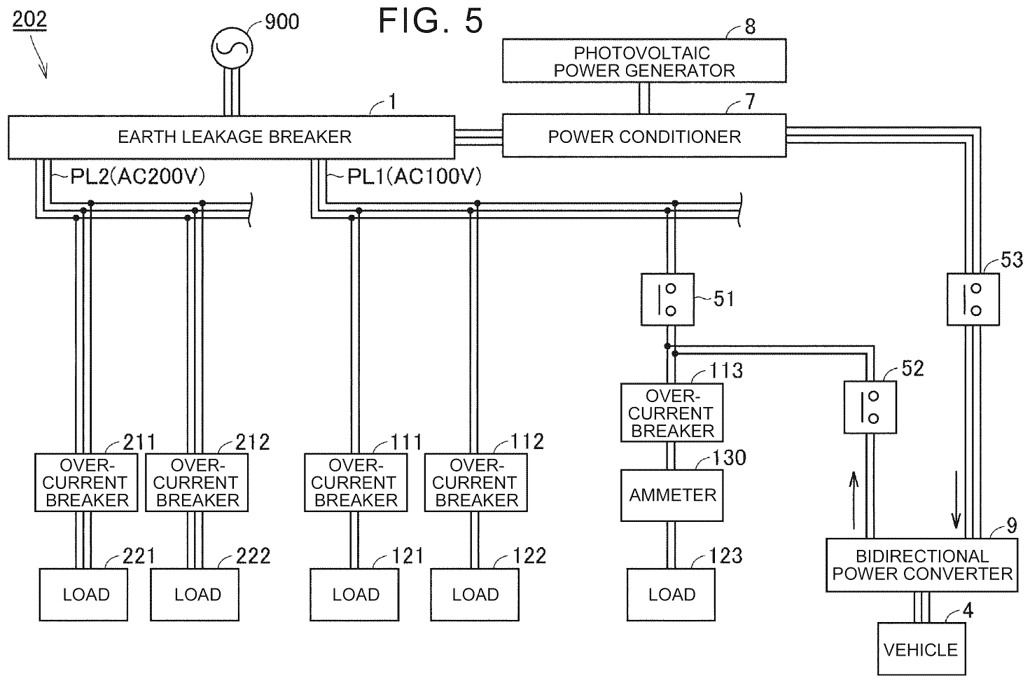

Note that, as will be described later in a second embodiment, when a charger is provided in addition to the power supply device 3, or when a bidirectional power converter is provided in place of the power supply device 3 (see FIGS. 4, 5, etc.), when the electricity rate is equal to or less than the reference rate (NO in S102), the controller 10 may control the charger or the bidirectional power converter so that the vehicle 4 is charged (S112, S113).

In FIG. 3, an example in which the subsequent processing is changed according to whether the electricity rate is higher than the reference rate has been described. Alternatively, the controller 10 may switch the processing according to whether it is currently is a night time (time of day during which the night fee is applied). This also saves on the electricity bill.

Alternatively, the controller 10 may switch processes depending on whether the power demand of the house 101A is at a peak. By supplying power from the vehicle 4 in a time period in which the power demand reaches a peak, it is possible to meet the peak of the power demand even if the maximum supply current from the grid power supply 900 is low, so that it is possible to reduce the so-called contract amperage. Therefore, the electricity bills can be saved.

As described above, in the first embodiment, the power supply system 101,102 includes the first electromagnetic switch 51 and the second electromagnetic switch 52. By using the first electromagnetic switch 51 and the second electromagnetic switch 52, it is possible to select which of the alternating current power from the grid power supply 900 and the alternating current power from the vehicle 4 is to be supplied from the load 121 to the load 123. More specifically, the alternating current power from the grid power supply 900 is selected by turning on the first electromagnetic switch 51 and turning off the second electromagnetic switch 52. On the other hand, the alternating current power from the vehicle 4 is selected by turning off the first electromagnetic switch 51 and turning on the second electromagnetic switch 52. Therefore, according to the first embodiment, power from the vehicle 4 can be supplied to the load with a simple system configuration in which only two electromagnetic switches are added.

When the detected value from the ammeter 130 is greater than the threshold β, the second electromagnetic switch 52 is turned off and the first electromagnetic switch 51 is turned on. Accordingly, power is less likely to be supplied from the vehicle 4 to the load 123 when there is a possibility of exceeding the discharging capability of the vehicle 4.

### Second Embodiment

In the second embodiment, a configuration in which the vehicle can be charged by the power generated by the photovoltaic power generator will be described.

### System Configuration

FIG. 4 is a circuit block diagram illustrating a first example of a configuration of a power supply system according to the second embodiment; The power supply system 201 illustrated in FIG. 4 is different from the power supply system 101,102 (see FIGS. 1 and 2) according to the first embodiment in that it further includes a third electromagnetic switch 53, a charger 6, a power conditioner (PCS: Power Conditioning System) 7, and a photovoltaic power generator 8.

A first end of the third electromagnetic switch 53 is electrically connected to the power conditioner 7. A second end of the third electromagnetic switch 53 is electrically connected to the charger 6. Thus, the third electromagnetic switch 53 is configured to switch between electrically connecting and disconnecting the power conditioner 7 to and from the charger 6 according to a control command from the controller 10 (see FIG. 1). The third electromagnetic switch 53 corresponds to the “third switch” according to the present disclosure.

The charger 6 is configured to be connected to the vehicle 4 via a charging cable (a charging cable and a power supply cable may be shared) which is not illustrated. The charger 6 includes a AC/DC converter, and is configured to charge the vehicle 4 by alternating current power from the power conditioner 7 when the vehicle 4 is connected. In this example, the power supply device 3 and the charger 6 correspond to the “power converter” according to the present disclosure.

The power conditioner 7 receives direct current power from the photovoltaic power generator 8 and converts the direct current power into alternating current power. The power conditioner 7 outputs the alternating current power to the earth leakage breaker 1 and also outputs the alternating current power to the charger 6 via the third electromagnetic switch 53.

The configuration of the power supply system 201 other than the third electromagnetic switch 53, the charger 6, the power conditioner 7, and the photovoltaic power generator 8 is the same as the corresponding configuration of the power supply systems 101, 102, and thus a detailed description thereof will not be repeated.

FIG. 5 is a circuit block diagram illustrating a second example of a configuration of a power supply system according to the second embodiment. The power supply system 202 shown in FIG. 5 is different from the power supply system 201 (see FIG. 4) in that a bidirectional power converter 9 is provided instead of the power supply device 3 and the charger 6 (in other words, in that the power supply device 3 and the charger 6 are integrated into one).

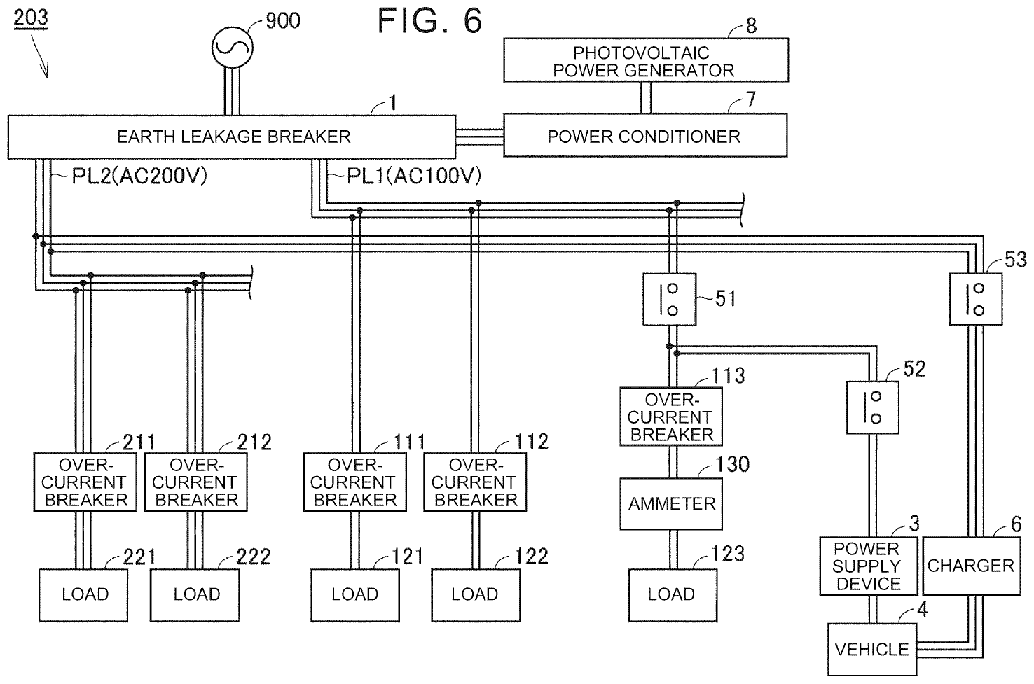

FIG. 6 is a circuit block diagram illustrating a third example of a configuration of a power supply system according to the second embodiment. The power supply system 203 illustrated in FIG. 6 is different from the power supply system 201 (see FIG. 4) in that the first end of the third electromagnetic switch 53 is electrically connected to the earth leakage breaker 1 (electrical path PL2 for AC 200 V) instead of the power conditioner 7. In FIG. 6, a bidirectional power converter 9 may be provided instead of the power supply device 3 and the charger 6.

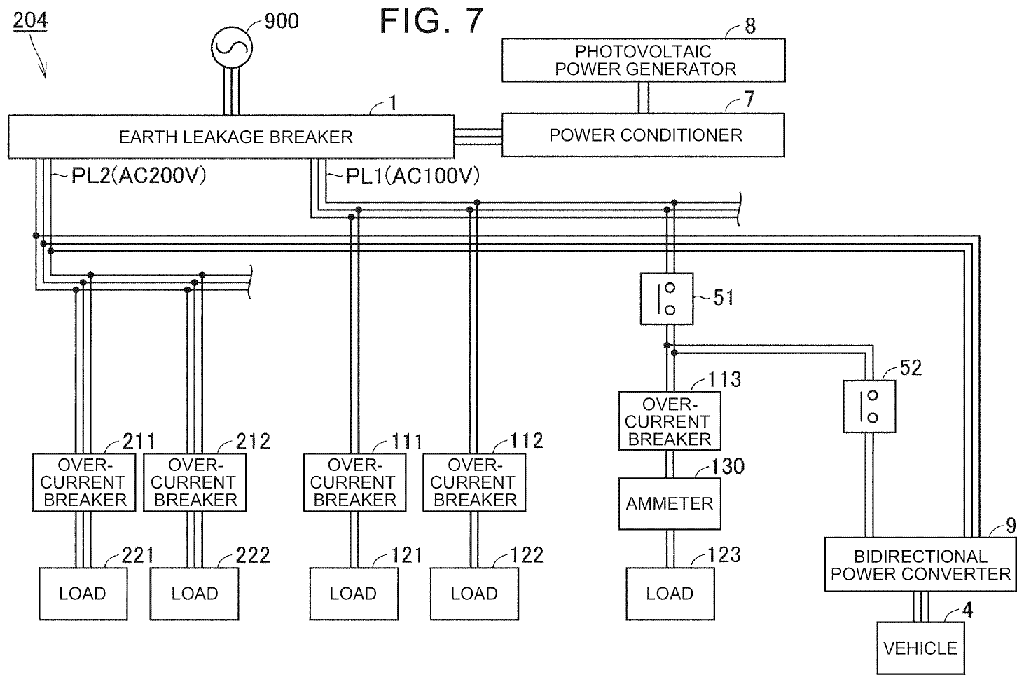

FIG. 7 is a circuit block diagram illustrating a fourth example of a configuration of a power supply system according to the second embodiment; The power supply system 204 shown in FIG. 7 differs from the power supply system 202 (see FIG. 5) in the following two points. A first difference is that the bidirectional power converter 9 is electrically connected to the earth leakage breaker 1 (electrical path PL2 for AC 200 V). A second difference is that the power supply system 204 does not include the third electromagnetic switch 53, and the bidirectional power converter 9 can switch between power supply and charging of the vehicle 4.

The other configurations of the power supply systems 202 to 204 illustrated in FIGS. 5 to 7 are the same as the corresponding configurations of the power supply system 201 illustrated in FIG. 4, and thus detailed description thereof will not be repeated.

### Processing Flow

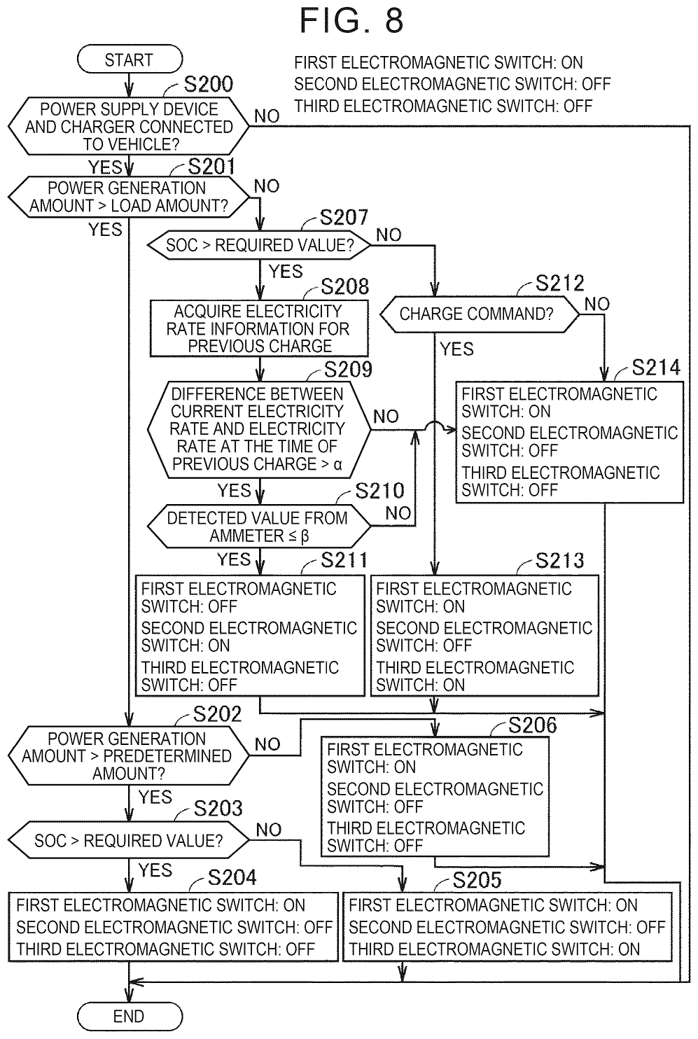

FIG. 8 is a flowchart illustrating a second example of a processing procedure related to control of an electromagnetic switch. The power supply system 201 illustrated in FIG. 4 will be described as an example. It is assumed that the first electromagnetic switch 51 is on, the second electromagnetic switch 52 is off, and the third electromagnetic switch 53 is off at the start of the series of processes.

In S200, the controller 10 determines whether the power supply device 3 and the charger 6 are connected to the vehicle 4. When the power supply device 3 and the charger 6 are connected to the vehicle 4 (YES in S200), the controller 10 proceeds to S201. When the power supply device 3 and the charger 6 are not connected to the vehicle 4 (NO in S200), the controller 10 ends the process. Note that S200 process may be omitted.

In S201, the controller 10 acquires information on the generated power of the photovoltaic power generator 8 and also acquire information on the consumed power (load power) of each load in the house 101A. The controller 10 determines whether the amount of power generation (power generation amount) within the specified time is larger than the amount of load power (load amount) within the same specified time. When the power generation amount is larger than the loading amount (YES in S201), the controller 10 proceeds to S202.

In S202, the controller 10 determines whether the power generation amount of the photovoltaic power generator 8 is larger than a predetermined amount. The predetermined amount is determined to be an amount of electric power sufficient to charge the vehicle 4. When the power generation amount of the photovoltaic power generator 8 is larger than the predetermined amount (YES in S202), the controller 10 proceeds to S203.

In S203, the controller 10 determines whether the SOC of the vehicle 4 is higher than the required value. As described above, the required value may be set to a value corresponding to the amount of electric power required for driving the next day of the vehicle 4. When the SOC is higher than the required value (YES in S203), the controller 10 turns on the first electromagnetic switch 51, turns off the second electromagnetic switch 52, and turns off the third electromagnetic switch 53 (S204). When the SOC is higher than the required value (YES in S203), that is, the power generation amount of the photovoltaic power generator 8 is enough to charge the vehicle 4, but the amount of electric power required for traveling is already stored in the vehicle 4. At this time, neither the power supply from the vehicle 4 nor the charging of the vehicle 4 is performed. The load 123 is supplied with the alternating current power of the grid power supply 900 or the generated power of the photovoltaic power generator 8 (power after AC conversion).

When the SOC is equal to or less than the required value (NO in S203), that is, when the power generation amount of the photovoltaic power generator 8 is enough to charge the vehicle 4 and the amount of power stored in the vehicle 4 is insufficient, the controller 10 turns on the first electromagnetic switch 51, turns off the second electromagnetic switch 52, and turns on the third electromagnetic switch 53 (S205). At this time, the vehicle 4 is charged by the power generated by the photovoltaic power generator 8. The load 123 is supplied with the alternating current power of the grid power supply 900 or the generated power of the photovoltaic power generator 8.

Returning to S202, when the power generation amount of the photovoltaic power generator 8 is equal to or less than the predetermined amount (NO in S202), that is, when the power generation amount is larger than the load amount but is not enough to charge the vehicle 4, the controller 10 turns on the first electromagnetic switch 51, turns off the second electromagnetic switch 52, and turns off the third electromagnetic switch 53 (S206). At this time, neither the power supply from the vehicle 4 nor the charging of the vehicle 4 is performed. The load 123 is supplied with the alternating current power of the grid power supply 900 or the generated power of the photovoltaic power generator 8.

Returning to S201, when the power generation amount of the photovoltaic power generator 8 is equal to or less than the load amount (NO in S201), that is, when the power demand of the house 101A cannot be satisfied only by the photovoltaic power generator 8, the controller 10 proceeds to S207. In S207, the controller 10 determines whether the SOC of the vehicle 4 is higher than the required value. The required value may be the same value as the required value of S203, or may be a different value.

When the SOC is higher than the required value (YES in S207), that is, when a sufficient amount of electric energy is stored in the vehicle 4, the controller 10 proceeds to S208. When the SOC is equal to or less than the required value (NO in S207), the controller 10 proceeds to S212.

In S208, the controller 10 acquires, for example, from an energy management server (not shown), information on the electricity rate when the vehicle 4 was last charged. Then, in S209, the controller 10 calculates a difference between the current electricity rate and the electricity rate at the time of the previous charge whose information was acquired in S208, and determines whether the difference therebetween is equal to or greater than the threshold α. When the difference is greater than the threshold α (YES in S209), the controller 10 proceeds to S210. When the difference is equal to or less than the threshold α (NO in S209), the controller 10 proceeds to S214. In S209, the same processes as those in S106 of FIG. 3 are performed, and thus detailed description thereof will be omitted.

In S210, the controller 10 determines whether the measured value (current value) from the ammeter 130 is equal to or less than the threshold β. When the measured value from the ammeter 130 is equal to or less than the threshold β (YES in S210), the controller 10 proceeds to S211. When the measured value from the ammeter 130 is greater than the threshold β (NO in S210), the controller 10 proceeds to S214.

The controller 10 turns off the first electromagnetic switch 51, turns on the second electromagnetic switch 52, and turns off the third electromagnetic switch 53 (S211). That is, power is supplied from the vehicle 4 to the load 123 instead of from the grid power supply 900.

When SOC is equal to or less than the required value (NO in S207), that is, when there is no sufficient margin to supply power to the outside to the electric energy stored in the vehicle 4, the controller 10 determines whether there is a charge command for the vehicle 4 (S212).

When there is a charge command (YES in S212), the controller 10 turns on the first electromagnetic switch 51, turns off the second electromagnetic switch 52, and turns on the third electromagnetic switch 53 (S213). At this time, the vehicle 4 is charged by the electric power generated by the photovoltaic power generator 8. The load 123 is supplied with alternating current power from the grid power supply 900 or power generated by the photovoltaic power generator 8.

When there is no charge command (NO in S212), the controller 10 turns on the first electromagnetic switch 51, turns off the second electromagnetic switch 52, and turns off the third electromagnetic switch 53 (S214). At this time, neither the power supply from the vehicle 4 nor the charging of the vehicle 4 is performed.

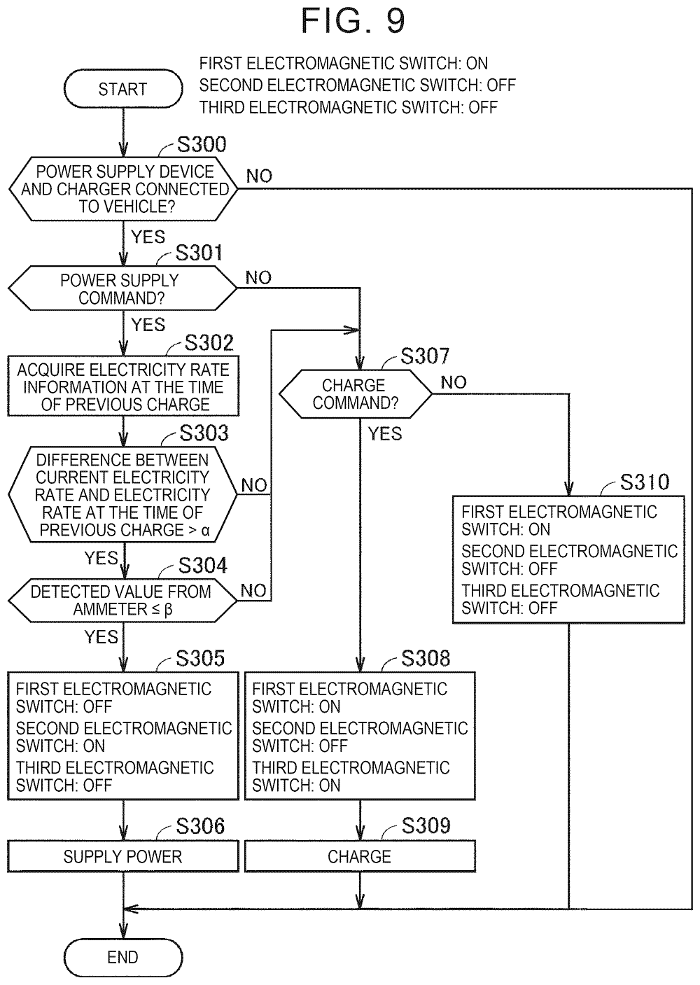

FIG. 9 is a flowchart illustrating a third example of a processing procedure related to control of an electromagnetic switch. The power supply system 201 shown in FIG. 4 will be described as an example. It is assumed that the first electromagnetic switch 51 is on, the second electromagnetic switch 52 is off, and the third electromagnetic switch 53 is off at the start of the series of processes.

In S300, the controller 10 determines whether the power supply device 3 and the charger 6 are connected to the vehicle 4. When the power supply device 3 and the charger 6 are connected to the vehicle 4 (YES in S300), the controller 10 proceeds to S301. When the power supply device 3 and the charger 6 are not connected to the vehicle 4 (NO in S300), the controller 10 ends the process. Note that the process of S300 may be omitted.

In S301, the controller 10 determines whether there is a power supply command. When there is a power supply command (YES in S301), the controller 10 proceeds to S302. When there is no power supply command (NO in S301), the controller 10 proceeds to S307.

In S302, the controller 10 acquires, for example, from an energy management server (not shown), information on the electricity rate when the vehicle 4 was last charged. Then, in S303, the controller 10 calculates the difference between the current electricity rate and the electricity rate at the time of the previous charge whose information was acquired in S302, and determines whether the difference is equal to or greater than the threshold α. When the difference is greater than the threshold α (YES in S303), the controller 10 proceeds to S304. When the difference is equal to or less than the threshold α (NO in S303), the controller 10 proceeds to S307. In S303, the same processes as those in S106 of FIG. 3 are performed, and thus detailed explanation thereof will be omitted.

In S304, the controller 10 determines whether the measured value (current value) from the ammeter 130 is equal to or less than the threshold β. When the measured value from the ammeter 130 is equal to or less than the threshold β (YES in S304), the controller 10 proceeds to S305. When the measured value from the ammeter 130 is greater than the threshold β (NO in S304), the controller 10 proceeds to S307.

In S305, the controller 10 turns off the first electromagnetic switch 51, turns on the second electromagnetic switch 52, and turns off the third electromagnetic switch 53. Then, the controller 10 controls the power supply device 3 so as to start power supply from the vehicle 4 (S306).

In S307, the controller 10 determines whether there is a charge command. When there is a charge command (YES in S307), the controller 10 proceeds to S308, turns on the first electromagnetic switch 51, turns off the second electromagnetic switch 52, and turns on the third electromagnetic switch 53. The controller 10 then controls the charger 6 to initiate charging of the vehicle 4 (S309). The load 123 is supplied with alternating current power from the grid power supply 900 or power generated by the photovoltaic power generator 8.

When there is neither the power supply command nor the charge command (NO in S307), the controller 10 proceeds to S310, turns on the first electromagnetic switch 51, turns off the second electromagnetic switch 52, and turns off the third electromagnetic switch 53. In this case, neither the power supply from the vehicle 4 nor the charging of the vehicle 4 is performed. The load 123 is supplied with alternating current power from the grid power supply 900 or power generated by the photovoltaic power generator 8.

In FIGS. 8 and 9, it has been described that the third electromagnetic switch 53 is turned on or off. As shown in FIG. 7, even in a system configuration in which the third electromagnetic switch 53 is not provided, a person skilled in the art will appreciate that the same function can be realized by switching the charging and the power supply by the bidirectional power converter 9.

As described above, in the second embodiment, the power supply systems 201 to 204 include the first electromagnetic switch 51 and the second electromagnetic switch 52 as in the first embodiment. Thus, the electric power from the vehicle 4 can be supplied to the load with a simple system configuration in which only two electromagnetic switches are added. In addition, in the second embodiment, the power supply systems 201 to 203 include the third electromagnetic switch 53. Thus, the vehicle 4 can be charged by the electric power generated by the photovoltaic power generator 8 in addition to the electric power supplied from the vehicle 4 with a simple system configuration in which only the third electromagnetic switch is added.

In the above embodiment, an example in which an earth leakage breaker is provided in the power supply system has been described, but the present disclosure is not limited to this. Instead of the leakage breaker, an overcurrent breaker that electrically cuts off the grid power supply 900 and the electrical paths PL1, PL2 in case of an overcurrent (when an overcurrent is detected) or a leakage breaker with an overcurrent breaker that electrically cuts off the grid power supply 900 and the electrical paths PL1, PL2 in case of an overcurrent and in case of an earth leakage (when an earth leakage is detected) may be provided.

In the above embodiment, the power supply device 3 and the bidirectional power converter 9 supply power to the load 123 connected to the electrical path PL1 for AC 100 V, but the present disclosure is not limited thereto. A power supply device or a bidirectional power converter may be provided for supplying power from the vehicle 4 to loads connected to the electrical path PL2 for AC 200 V. The power supply device and the bidirectional power converter correspond to the “power converter” of the present disclosure.

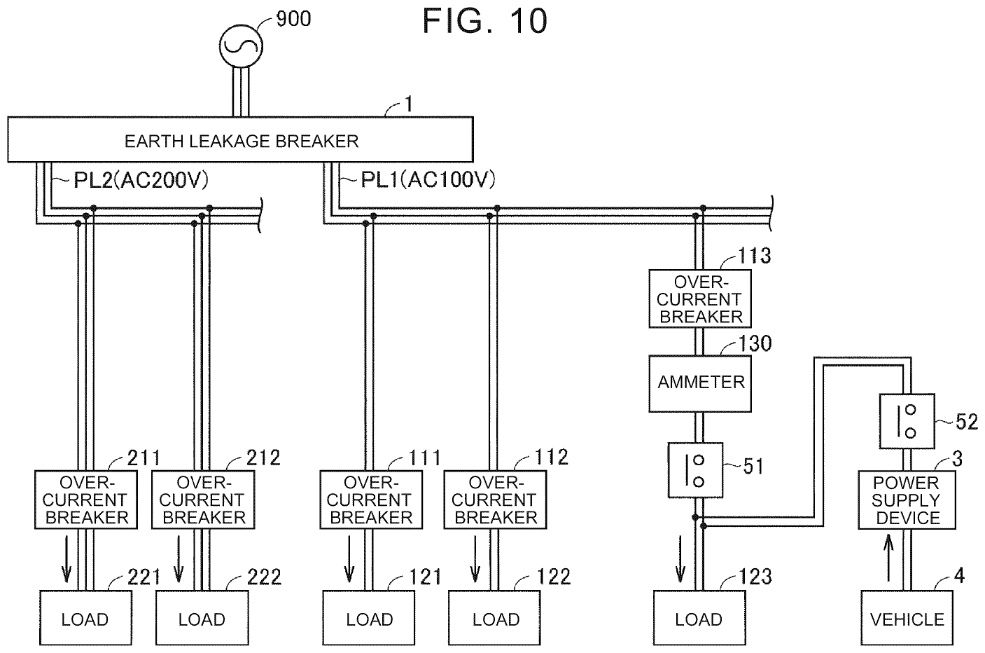

In the above embodiment, the first electromagnetic switch 51 is electrically connected to the earth leakage breaker 1 and the overcurrent breaker 113, but the present disclosure is not limited thereto. As shown in FIG. 10, the first end of the first electromagnetic switch 51 may be electrically connected to the overcurrent breaker 113, and the second end of the first electromagnetic switch 51 may be electrically connected to the load 123. In this case, the first end of the second electromagnetic switch 52 is electrically connected to the overcurrent breaker 113 and the load 123. Although FIG. 10 illustrates a modification of the power supply system 101 of FIG. 1, the power supply systems 102, 201, 202, 203, and 204 may be modified in the same manner.

The embodiments disclosed herein are to be understood as being exemplary and not to be construed as being limitative of the present disclosure in every respect. It is intended that the scope of the disclosure be defined by the appended claims rather than the description of the embodiments described above, and that all changes within the meaning and range of equivalency of the claims be embraced therein.

What is claimed is:

1. A power supply system configured to supply alternating current power from a grid power supply to a power load in a house, the power supply system comprising:
a current breaker configured to receive the alternating current power supplied from the grid power supply to the house and to shut off in case of either or both of an earth leakage and an overcurrent;
a load breaker configured to electrically disconnect the current breaker from the power load;
a power converter configured to supply alternating current power from a vehicle to the power load when the vehicle is connected to the power converter;
a first switch configured to switch between electrically connecting and disconnecting the current breaker to and from the load breaker;
a second switch configured to switch between electrically connecting and disconnecting the first switch to and from the power converter and configured to switch between electrically connecting and disconnecting the load breaker to and from the power converter; and
a measuring instrument configured to measure at least one of the following values between the load breaker and the power load: a current value, a voltage value, and a power value,
wherein the power supply system is configured to close the first switch and open the second switch when the vehicle is connected to the power converter and a measured value from the measuring instrument is greater than a threshold.

2. The power supply system according to claim 1, wherein:
the house includes a power conditioner configured to receive power generated by a photovoltaic power generator;
the power converter is configured to charge the vehicle with alternating current power from the power conditioner when the vehicle is connected to the power converter;
the power supply system further includes a third switch configured to switch between electrically connecting and disconnecting the power conditioner to and from the power converter; and
the power supply system is configured to close the first switch, open the second switch, and open the third switch when the vehicle is connected to the power converter and the measured value is greater than the threshold.

3. The power supply system according to claim 1, wherein:
the power converter is further configured to charge the vehicle with alternating current power from the current breaker when the vehicle is connected to the power converter;
the power supply system further includes a third switch configured to switch between electrically connecting and disconnecting the current breaker to and from the power converter; and
the power supply system is configured to close the first switch, open the second switch, and open the third switch when the vehicle is connected to the power converter and the measured value is greater than the threshold.

4. The power supply system according to claim 1, wherein the power supply system is configured to open the first switch and close the second switch when the vehicle is connected to the power converter, the measured value is equal to or less than the threshold, and a current electricity rate is higher than an electricity rate when charging of electricity currently charged to the vehicle has been performed.

5. The power supply system according to claim 1, wherein the power supply system is configured to close the first switch and open the second switch when the measured value from the measuring instrument is greater than the threshold with the vehicle being connected to the power converter, the first switch being open, and the second switch being closed.

6. The power supply system according to claim 1, wherein the power supply system is configured to keep the first switch closed and keep the second switch open when the measured value from the measuring instrument is greater than the threshold with the vehicle being connected to the power converter, the first switch being closed, and the second switch being open.
